(19) United States
(12) Patent Application Publication
(10) Pub. No.: US 2026/0171925 A1
(43) Pub. Date: Jun. 18, 2026

(54) POWER MODULE FOR VEHICLE INCLUDING CAPACITOR COMPONENT AND MOTOR DRIVING APPARATUS INCLUDING THE SAME

(71) Applicants: HYUNDAI MOTOR COMPANY, Seoul (KR); KIA CORPORATION, Seoul (KR)

(72) Inventors: Han Jin Do, Hwaseong-si (KR); Dong Hwan Lee, Hwaseong-si (KR); Jin Myeong Yang, Hwaseong-si (KR); Sung Won Park, Hwaseong-si (KR)

(73) Assignees: HYUNDAI MOTOR COMPANY, Seoul (KR); KIA CORPORATION, Seoul (KR)

(21) Appl. No.: 19/205,498

(22) Filed: May 12, 2025

(30) Foreign Application Priority Data
Dec. 13, 2024 (KR) 10-2024-0185633

(51) Int. Cl. H02M 7/00; B60L 15/00; H02M 1/12; H02M 1/44; H02M 7/5387

(52) U.S. Cl. CPC H02M 7/003; B60L 15/007; H02M 1/12; H02M 1/44; H02M 7/5387; B60L 2210/40

(57) ABSTRACT

The power module for a vehicle is provided. The power module includes a first circuit board including a first insulating layer and a first metal layer disposed on the first insulating layer, a lead frame including a plurality of direct current (DC) electrodes arranged on a side of the first circuit board, a first switching unit electrically connected to the plurality of DC electrodes and disposed on the first circuit board, and a capacitor component mounted on the lead frame to be electrically connected between the plurality of DC current electrodes.

### CROSS-REFERENCE TO RELATED APPLICATION(S)

This application claims benefit of priority to Korean Patent Application No. 10-2024-0185633 filed on Dec. 13, 2024 in the Korean Intellectual Property Office, the disclosure of which is incorporated herein by reference in its entirety.

### TECHNICAL FIELD

The present disclosure relates to a power module for a vehicle including a capacitor component and a motor driving apparatus including the same.

### BACKGROUND

Eco-friendly vehicles may include hybrid vehicles (HEVs), plug-in hybrid vehicles (PHEVs), electric vehicles (EVs), fuel cell electric vehicles (FCEVs), and the like. A power module of eco-friendly vehicles receives DC current from a high-voltage battery, converts the DC current into AC current, supplies the same to a motor, and the torque and rotational speed of the motor are controlled by adjusting the magnitude and phase of the AC current.

### SUMMARY

An electrical path of a power module for a vehicle may act as parasitic inductance, and the parasitic inductance may cause instability (e.g., fluctuations, surges, or ringing) of current and/or voltage.

An aspect of the present disclosure is to provide a power module for a vehicle including a capacitor component and a motor driving apparatus including the same, capable of (e.g., efficiently) reducing the influence of parasitic inductance of the power module for a vehicle (e.g., fluctuations, surges, or ringing of voltage/current due to switching for power conversion) and increasing the power conversion efficiency of the power module (e.g., switching unit) for a vehicle or reducing the required specifications (e.g., withstand voltage characteristics).

According to an aspect of the present disclosure, a power module for a vehicle includes a first circuit board including a first insulating layer and a first metal layer disposed on the first insulating layer, a lead frame including a plurality of direct current (DC) electrodes arranged on one side of the first circuit board, a first switching unit electrically connected to the plurality of DC electrodes and disposed on the first circuit board, and a capacitor component mounted on the lead frame so as to be electrically connected between the plurality of DC current electrodes.

The power module may further include a fused portion connected between the capacitor component and at least one of the plurality of DC electrodes, the fused portion including a conductive material having a lower melting point than that of the plurality of DC electrodes.

The capacitor component may be disposed in a bridge structure crossing between the plurality of DC electrodes, and the capacitor component may include a capacitor body and a plurality of capacitor electrodes arranged in the capacitor body, and one of the plurality of capacitor electrodes may be electrically connected to one of the plurality of DC electrodes through a portion of the fused portion, and another of the plurality of capacitor electrodes may be electrically connected to another of the plurality of DC electrodes through another portion of the fused portion.

The capacitor component may include a capacitor body, a plurality of capacitor electrodes arranged in the capacitor body, and a capacitor bonding wire connected to one of the plurality of capacitor electrodes, the other of the plurality of capacitor electrodes may be electrically connected to one of the plurality of DC electrodes, and the capacitor bonding wire may connect one of the plurality of capacitor electrodes to another of the plurality of DC electrodes.

The power module may further include an encapsulant disposed on the first circuit board and encapsulating the first switching unit and the capacitor component.

The power module may further include an encapsulant disposed on the first circuit board and encapsulating the first switching unit and a portion of each of the plurality of DC electrodes, wherein the capacitor component is separated from the encapsulant.

The power module may further include a second circuit board including a second insulating layer and a second metal layer disposed on the second insulating layer, wherein the capacitor component does not overlap the first and second circuit boards in a direction in which the first and second circuit boards face each other.

The power module may further include a second circuit board including a second insulating layer and a second metal layer disposed on the second insulating layer, wherein one of the plurality of DC electrodes is electrically connected to the first metal layer and another of the plurality of DC electrodes is electrically connected to the second metal layer, and the capacitor component overlaps the plurality of DC electrodes in a direction in which the plurality of DC electrodes face each other.

The power module may further include a capacitor spacer disposed between the plurality of DC electrodes to overlap the capacitor component in a direction in which the plurality of DC electrodes face each other.

The capacitor component may include a capacitor body and a plurality of capacitor electrodes arranged in the capacitor body, and one of the plurality of capacitor electrodes may be electrically connected to one of the plurality of DC electrodes, and another of the plurality of capacitor electrodes may be electrically connected to another of the plurality of DC electrodes.

The power module may further include a via spacer disposed between the first circuit board and the second circuit board to electrically connect the first metal layer to the second metal layer.

The power module may further include a switching unit spacer disposed between the first switching unit and the second circuit board to electrically connect the first switching unit to the second metal layer.

The lead frame may further include a plurality of alternating current (AC) electrodes electrically connected to the first switching unit, and the plurality of DC electrodes may be arranged adjacently so as not to have the plurality of AC electrodes therebetween.

The power module may further include a signal lead electrically connected to the first switching unit and disposed on the other side of the first circuit board.

The lead frame may further include a plurality of DC busbars electrically connected between a DC link capacitor and the plurality of DC electrodes, and the capacitor component may be mounted on at least one of the plurality of DC busbars.

The lead frame may further include an AC electrode electrically connected to the first switching unit, and one end of each of the plurality of DC electrodes may be connected to each of the plurality of DC busbars, and a distance from the other end of each of the plurality of DC electrodes to the capacitor component may be greater than a distance between one end and the other end of the AC electrode.

The power module may further include a capacitor spacer disposed between the plurality of DC busbars to overlap the capacitor component in a direction in which the plurality of DC busbars face each other, wherein the capacitor component is disposed between the plurality of DC busbars.

The power module may further include a second switching unit disposed on the first circuit board, and a third switching unit arranged on the first circuit board, wherein the first switching unit includes a plurality of first semiconductor chips, the second switching unit includes a plurality of second semiconductor chips, and the third switching unit includes a third semiconductor chip.

The first switching unit may be disposed in a central portion of the first circuit board, the second switching unit may be disposed outwardly of the first switching unit on the first circuit board, and the third switching unit may be disposed outwardly of the first switching unit on the first circuit board.

According to another aspect of the present disclosure, a motor driving apparatus includes the power module for a vehicle described above, wherein the first switching unit includes a 1-1 switching element and a 1-2 switching element and corresponds to one leg of a first inverter, the second switching unit includes a 2-1 switching element and a 2-2 switching element and corresponds to one leg of a second inverter, and one end of the third switching unit is connected between a first node between the 1 -1 switching element and the 1-2 switching element and a second node between the 2-1 switching element and the 2-2 switching element and constitutes part of a changeover switch.

### BRIEF DESCRIPTION OF DRAWINGS

The above and other aspects and features of the present disclosure may be understood from the following detailed description, taken in conjunction with the accompanying drawings.

FIG. 1A is a circuit diagram illustrating that a capacitor component of a power module for a vehicle cancels out parasitic inductance according to an embodiment of the present disclosure.

FIG. 1B is a circuit diagram illustrating a power module for a vehicle and a motor driving apparatus including the same according to an embodiment of the present disclosure.

FIG. 2 is a plan view illustrating a power module for a vehicle according to an embodiment of the present disclosure.

FIGS. 3A, 3B, and 3C are perspective views illustrating a power module for a vehicle according to an embodiment of the present disclosure.

FIGS. 4A, 4B, and 4C are perspective views illustrating a structure in which a capacitor component of a power module for a vehicle according to an embodiment of the present disclosure includes a capacitor bonding wire.

FIGS. 5A, 5B, and 5C are side views illustrating a power module for a vehicle according to an embodiment of the present disclosure.

FIGS. 6A, 6B, and 6C are side views illustrating a structure in which a capacitor component of a power module for a vehicle according to an embodiment of the present disclosure is arranged between a plurality of DC electrodes (or a plurality of DC busbars).

FIGS. 7A, 7B, and 7C are side views illustrating a combination of a capacitor component and a capacitor spacer of a power module for a vehicle according to one embodiment of the present disclosure.

### DETAILED DESCRIPTION

While the present disclosure may be modified in various manners and may take on various alternative forms, specific embodiments thereof are illustrated in the drawings and described in detail below. However, the present disclosure is not limited to the particular forms disclosed, but on the contrary, the present disclosure covers modifications, equivalents, and alternatives falling within the spirit and scope of the present disclosure.

It may be understood that, although the terms “first,” “second,” and the like may be used herein to describe various elements, these elements are not limited by these terms. These terms are used to distinguish one element from another. For example, a first element may be termed a second element, and a second element may similarly be termed a first element without departing from the scope of the present disclosure. As used herein, the term “and/or” includes combinations of one or more of the associated listed items.

The terms used herein to describe embodiments of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context indicates otherwise. It may be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless provided in a different manner, the terms used herein including technical and scientific terms have the same meanings as understood by those skilled in the art to which the present disclosure pertains. Such terms as provided in generally used dictionaries should be construed as having the same meanings as those of the contexts of the related art, and unless provided in the application, they should not be construed to have (e.g., ideally or excessively) formal meanings.

In this specification, vehicles refer to a variety of vehicles that move transported objects, such as people, animals, or goods, from a starting point to a destination. These vehicles are not limited to vehicles that run on roads or tracks.

Hereinafter, embodiments of the present disclosure are described with reference to the accompanying drawings.

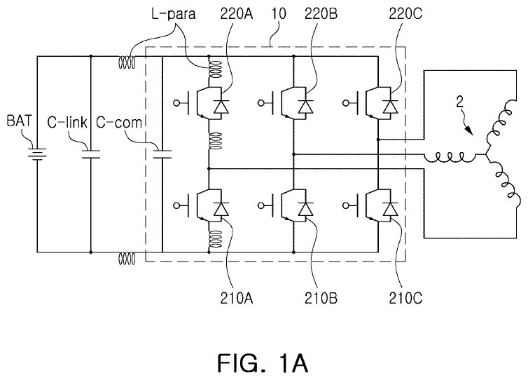

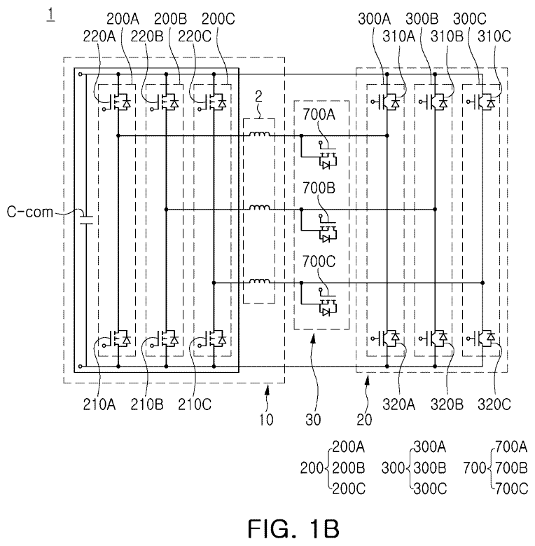

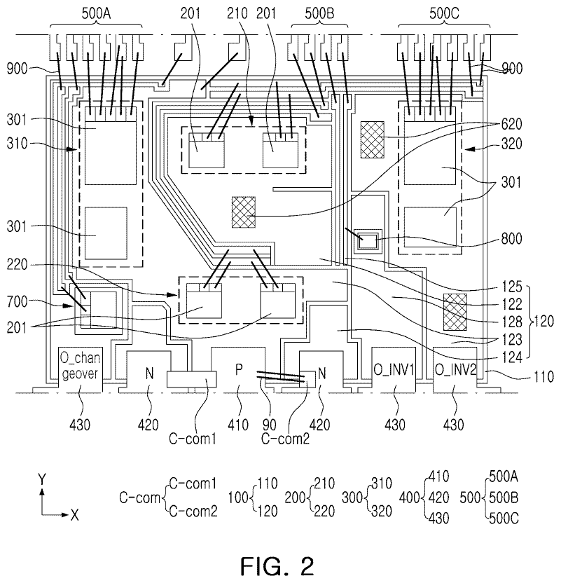

Referring to FIG. 1A, a power module for a vehicle according to an embodiment of the present disclosure may include a first inverter 10, may be electrically connected to a DC link capacitor C-link and a battery BAT outside the power module for a vehicle through a plurality of DC electrodes (e.g., 410 and 420 of FIG. 2), and may be electrically connected to a motor 2 outside the power module for a vehicle through an AC electrode (e.g., 430 of FIG. 2). Referring to FIG. 1B, depending on the embodiment (e.g., design), the power module for a vehicle may further include a second inverter 20 and a changeover switch 30.

Referring to FIGS. 1A and 1B, the first inverter 10 may include a first switching unit 200, and the first switching unit 200 may include three first switching units 200A, 200B, and 200C corresponding to three phases, respectively. The three first switching units 200A, 200B, and 200C may include three 1-1 switching elements 210A, 210B, and 210C and three 1-2 switching elements 220A, 220B, and 220C, respectively, and may correspond to one leg of the first inverter 10.

The second inverter 20 may include a second switching unit 300, and the second switching unit 300 may include three second switching units 300A, 300B, and 300C corresponding to three phases, respectively. The three second switching units 300A, 300B, and 300C may include three 2-1 switching elements 310A, 310B, and 310C and three 2-2 switching elements 320A, 320B, and 320C, respectively, and may correspond to one leg of the second inverter 20.

The changeover switch 30 may include a third switching unit 700, and the third switching unit 700 may include three third switching units 700A, 700B, and 700C corresponding to three phases, respectively. One end of each of the third switching unit 700A, 700B, and 700C is connected between a first node between the 1-1 switching elements 210A, 210B, and 210C and the 1-2 switching elements 220A, 220B, and 220C and a second node between the 2-1 switching elements 310A, 310B, and 310C and the 2-2 switching elements 320A, 320B, and 320C and may constitute part of the changeover switch 30.

When a direct current (DC) of the battery BAT provided in an electric vehicle is input to a motor driving apparatus 1 for a vehicle, the motor driving apparatus 1 for a vehicle may convert the input DC current into alternating current (AC) and output the same to the motor 2 to operate the motor 2. The first and second inverters 10 and 20 may convert the DC current into AC current.

The first inverter 10 may be operated at (e.g., all) times, and the second inverter 20 may be operated together with the first inverter 10 when the motor 2 requires high output. Accordingly, the motor driving apparatus 1 for a vehicle may increase the overall efficiency in a wide output range of the motor 2. The changeover switch 30 may connect the first inverter 10 to the second inverter 20, and may be turned ON to provide a Y connection between each phase winding of the motor 2 when (e.g., only) the first inverter 10 is operated, and may be turned OFF when the second inverter 20 is also operated.

Referring to FIG. 2, the first switching unit 200 may include at least one of a plurality of first semiconductor chips 201, the second switching unit 300 may include at least one of a plurality of second semiconductor chips 301, and the third switching unit 700 may include a third semiconductor chip.

For example, the first switching unit 200 and the third switching unit 700 may be implemented as silicon carbide (SiC) chips, and the second switching unit 300 may be implemented as a Si chip. The second switching unit 300 may be selectively turned off, and thus, the second switching unit 300 may be implemented as a (e.g., relatively) low-performance Si chip. The frequency of use of the first switching unit 200 and the third switching unit 700 may be (e.g., relatively) high compared to the second switching unit 300, and thus, the first switching unit 200 and the third switching unit 700 may be implemented as (e.g., relatively) high-performance SiC chips. The semiconductor type of each switching element described above are examples according to the present disclosure and may not necessarily limited thereto, and various types of semiconductors may be applied.

The frequency of use of the first switching unit 200 may be higher than that of the second switching unit 300, and the number of switching elements of the first switching unit 200 may be greater than that of the third switching unit 700. Therefore, compared to the second switching unit 300 and the third switching unit 700, the first switching unit 200 may have a greater influence on the overall energy efficiency of the power module for a vehicle.

For example, the first switching unit 200 may be arranged in a central portion of a first circuit board 100, the second switching unit 300 may be disposed outwardly of the first switching unit 200 in the first circuit board 100, and the third switching unit 700 may be disposed outwardly of the first switching unit 200 in the first circuit board 100. Accordingly, an electrical distance between a lead frame 400 and the first switching unit 200 may be shortened, and parasitic impedance may also be reduced due to the simplification of the electrical path between the lead frame 400 and the first switching unit 200. The shortening of the electrical distance may refer to an increase in energy efficiency, and the increase in the energy efficiency of the first switching unit 200 may refer to an improvement in the overall energy efficiency of the power module for a vehicle. In addition, this structure may be a structure for minimizing an insulation distance of a signal lead 500 and may also reduce the overall size of the power module for a vehicle.

For example, the 1-2 switching elements 220A, 220B, and 220C of the first switching unit 200 and the 2-2 switching elements 320A, 320B, and 320C of the second switching unit 300 may be formed with the same potential difference, and by arranging the 1-2 switching elements 220A, 220B, and 220C of the first switching unit 200 and the 2-2 switching elements 320A, 320B, and 320C of the second switching unit 300 adjacently, an insulation distance other than the (e.g., required) insulation distance of the signal lead 500 may be eliminated, thereby reducing the size of the first circuit board 100.

The third switching unit 700 may be disposed adjacent to the 2-1 switching elements 310A, 310B, and 310C of the second switching unit 300. The third switching unit 700 may be formed to have the same potential difference as the 2-1 switching elements 310A, 310B, and 310C of the second switching unit 300, and since the third switching unit 700 and the 2-1 switching elements 310A, 310B, and 310C are arranged adjacent to each other, an insulation distance other than the (e.g., required) insulation distance of the signal lead 500 may be eliminated, thereby reducing the size of the first circuit board 100.

By disposing the signal lead 500 in a position adjacent to the 1-2 switching elements 220A, 220B, and 220C of the first switching unit 200, the insulation distance other than the (e.g., required) insulation distance of the signal lead 500 may be eliminated, thereby reducing the size of the first circuit board 100.

One end of the third switching unit 700 may be connected between the motor 2 and the second switching unit 300, and the other end thereof may be connected to the lead frame 400 so that, when they are mutually connected to be turned on outside the power module for a vehicle, they may be able to provide a Y-connection for each winding of the motor 2.

Referring to FIGS. 1A, 1B and 2, each of the three 1-1 switching elements 210A, 210B, and 210C, the three 1-2 switching elements 220A, 220B, and 220C, the three 2-1 switching elements 310A, 310B, and 310C, the three 2-2 switching elements 320A, 320B, and 320C, the three third switching units 700A, 700B, and 700C (e.g., total of 15) may include a structure in which a transistor and a diode are combined and may provide a switching operation between an ON state and an OFF state of the transistor according to a control signal input from an external source of the power module for a vehicle through a lead frame (e.g., 400 in FIG. 2). For example, the transistor may be implemented as an insulated gate bipolar transistor (IGBT) or a metal oxide semiconductor field effect transistor (MOSFET), but is not limited thereto.

The switching operation between the ON state and the OFF state of each switching element may cause a rapid change (e.g., recovery current of the switching element, and the like) in the current flowing between a drain terminal and a source terminal of the switching element. Capacitance of the DC link capacitor C-link may stabilize (e.g., balancing an instantaneous power difference between the battery and the first inverter) the instability (e.g., fluctuations, surges, or ringing) of the total DC current and total DC voltage of the first inverter 10 due to the rapid change in the current.

An electrical path between the switching element and the DC link capacitor C-link may act as a parasitic inductance L-para. In circuit theory, the product of the parasitic inductance L-para and a rate of rapid change in current due to the switching operation of the switching element may correspond to a voltage generated in the parasitic inductance L-para. Therefore, as the parasitic inductance L-para increases, the rapid change in current due to the switching operation of the switching element may increase the instability of the voltage (e.g., fluctuations, surges, or ringing). In this manner, the instability of the DC current and the instability of the DC voltage may be complementary to each other. Therefore, as the parasitic inductance L-para is lowered, the DC current and the DC voltage may be stabilized further overall.

The power module for a vehicle according to an embodiment of the present disclosure may include a capacitor component C-com. A current change occurring from the switching element may be affected by an output reactance of the switching element, and the output reactance may be reduced by an offset between a portion of the series parasitic inductance L-para (e.g., a portion corresponding between the capacitor component C-com and the DC link capacitor C-link) and a parallel capacitance of the capacitor component C-com. Accordingly, the parasitic inductance L-para may be (e.g., efficiently) offset and the influence of the parasitic inductance of the power module for a vehicle (e.g., fluctuation/surge/ringing of voltage/current due to switching for power conversion) may be (e.g., efficiently) reduced. In addition, by reducing the parasitic inductance L-para, the power module for a vehicle may further increase the power conversion efficiency (e.g., switching timing consistency between a plurality of switching elements) or reduce the required specifications of the power module for a vehicle (e.g., withstand voltage characteristics).

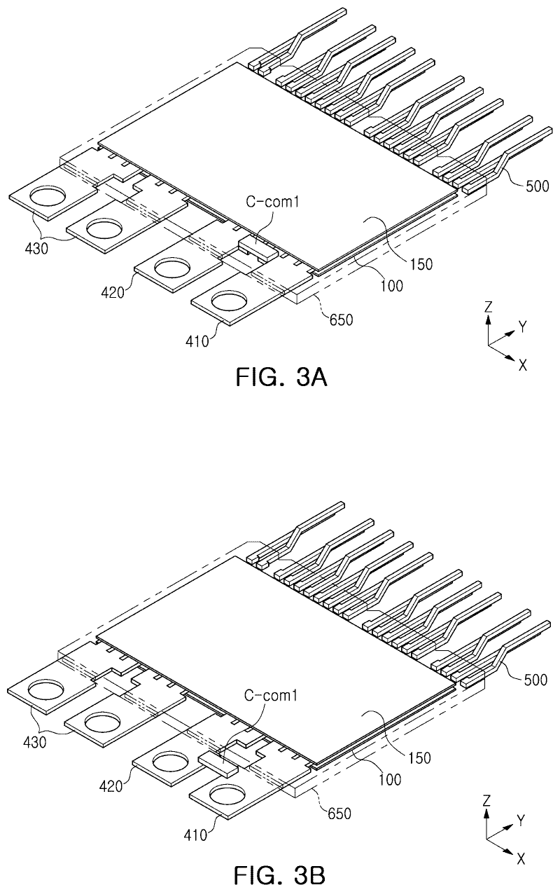

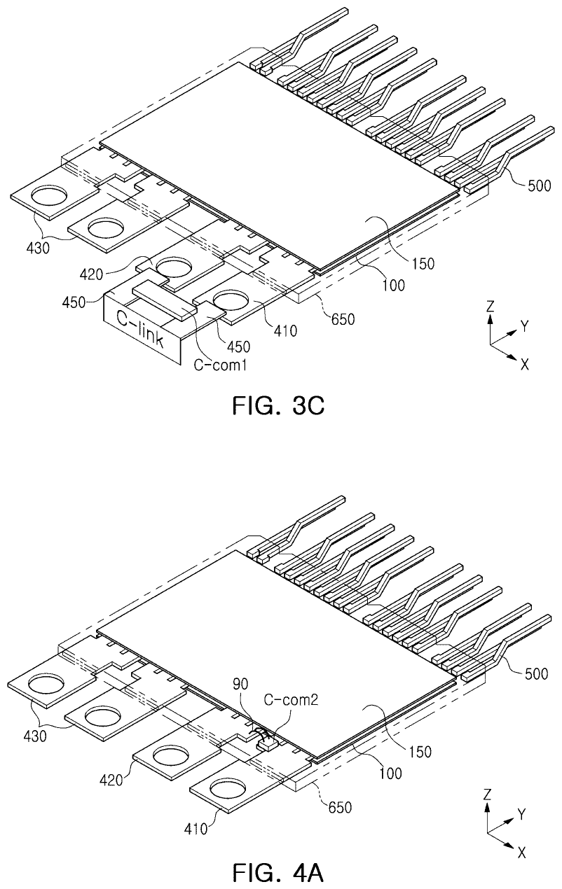

Referring to FIG. 2 and at least one of FIGS. 3A to 7C, the power module for a vehicle according to an embodiment of the present disclosure may include the first circuit board 100, the lead frame 400, the first switching unit 200, and capacitor components C-com, C-com1, C-com2, C-com3, and C-com4. Depending on the embodiment (e.g., design), the power module for a vehicle may further include at least one of a second circuit board 150 and the second switching unit 300. The first switching unit 200 may include at least one first semiconductor chip 201, and the second switching unit 300 may include at least one second semiconductor chip 301.

The first circuit board 100 may include a first insulating layer 110 and a first metal layer 120 disposed on the first insulating layer 110. The second circuit board 150 may include a second insulating layer 160 and a second metal layer 170 disposed on the second insulating layer 160. For example, each of the first and second circuit boards 100 and 150 may be implemented as an active metal brazed (AMB) substrate or a direct bonded copper (DBC) substrate, each of the first and second insulating layers 110 and 160 may be implemented as a ceramic layer, and each of the first and second metal layers 120 and 170 may be implemented as a copper layer, but is not limited thereto.

A portion of each of the first and second insulating layers 110 and 160 may overlap each of the first and second metal layers 120 and 170 in the vertical direction (e.g., a Z-direction), and the other portion of each of the first and second insulating layers 110 and 160 may not overlap each of the first and second metal layers 120 and 170 in the vertical direction (e.g., the Z-direction). For example, before patterning, each of the first and second metal layers may be formed to overlap the entire region of each of the first and second insulating layers 110 and 160, and a portion of each of the first and second metal layers before patterning may be removed by a patterning process (e.g., a photolithography process), and after patterning, each of the first and second metal layers 120 and 170 may include a plurality of patterns 122, 123, 124, 125, and 128 separated from each other, and the plurality of patterns 122, 123, 124, 125, and 128 may provide a plurality of electrical connection paths for the first and second semiconductor chips 201 and 301 of the first and second switching units 200 and 300.

For example, the first circuit board 100 may further include a third metal layer 130, and the second circuit board 150 may further include a fourth metal layer 180. For example, the third and fourth metal layers 130 and 180 may dissipate heat generated by the first and second semiconductor chips 201 and 301 and the first and second metal layers 120 and 170 to the outside of the power module for a vehicle and may be electrically separated from the first and second metal layers 120 and 170 by the first and second insulating layers 110 and 160. Alternatively, the third and fourth metal layers 130 and 180 may provide ground for the first and second switching units 200 and 300 and may be electrically connected to some patterns of the first and second metal layers 120 and 170 through conductive vias of the first and second insulating layers 110 and 160. Although not illustrated, cooling channels for cooling the power module for a vehicle may be in contact with a lower surface of the third metal layer 130 and an upper surface of the fourth metal layer 180.

The first and second switching units 200 and 300 may be electrically connected to a plurality of DC electrodes 410 and 420 and arranged on the first and second circuit boards 100 and 150 (e.g., arranged between the first and second circuit boards 100 and 150). For example, the first and second semiconductor chips 201 and 301 of the first and second switching units 200 and 300 may be implemented as at least one of an integrated circuit, a chip, and a die. Switching of the first and second switching units 200 and 300 may refer to switching between an ON state and an OFF state of the semiconductor device.

The first and second switching units 200 and 300 may receive a control signal from the outside of the power module through the signal lead 500 and may switch the ON/OFF state of the semiconductor device according to the control signal. According to the switching of the first and second switching units 200 and 300, the first and second switching units 200 and 300 may invert a DC current input through the lead frame 400 into an AC current.

For example, the first and second switching units 200 and 300 may be mounted on the upper surface of the first circuit board 100 via first and second connecting portions 215 and 315, respectively. For example, the first and second connecting portions 215 and 315 may be implemented as a structure also providing an electrical connection path, such as a bump or a solder ball, or may be implemented as an adhesive layer providing adhesiveness without an electrical connection path.

The lead frame 400 may include a plurality of DC electrodes 410 and 420 arranged on one side (e.g., in a −Y-direction) of the first and second circuit boards 100 and 150 and may further include an AC electrode 430. The plurality of DC electrodes 410 and 420 may include an N-type electrode and a P-type electrode. The plurality of DC electrodes 410 and 420 may be electrically connected to the battery (e.g., BAT of FIG. 1A), so that they may receive DC current from the battery (e.g., BAT of FIG. 1A) and transmit the DC current to the first and second semiconductor chips 201 and 301 through at least two of the plurality of patterns 122, 123, 124, 125, and 128 of the first metal layer 120. The AC electrode 430 may be electrically connected to the motor (e.g., 2 of FIG. 1A), and thus, the AC electrode 430 may receive AC current output from the first and second semiconductor chips 201 and 301 through the first metal layer 120 and output the same to the motor (e.g., 2 of FIG. 1A).

The capacitor components C-com, C-com1, C-com2, C-com3, and C-com4 may be mounted on the lead frame 400 so as to be electrically connected between the plurality of DC electrodes 410 and 420. The capacitor components C-com, C-com1, C-com2, C-com3, and C-com4 may be manufactured separately from the power module for a vehicle, so that they may be designed to (e.g., efficiently) form capacitance, may be provided in the process of manufacturing a power module for a vehicle, and may be connected and fixed to the lead frame 400. This may refer to the mounting.

For example, the parasitic inductance (e.g., L-para in FIG. 1A) of the power module for a vehicle assembled with the other structures (e.g., the circuit board, the switching unit, and the lead frame) excluding the capacitor components C-com, C-com1, C-com2, C-com3, and C-com4 may be slightly variable depending on the embodiment (e.g., design) specifications and/or process dispersion of the other structures. The capacitor components C-com, C-com1, C-com2, C-com3, and C-com4 may be additionally disposed in the power module for a vehicle assembled with the other structures and may be selected as an optimized one among various capacitor component types, so that they may provide the power module for a vehicle with a more optimized capacitance (and/or other characteristics, such as withstand voltage or temperature characteristics) to offset the current parasitic inductance (e.g., L-para in FIG. 1A).

For example, the capacitor component may be implemented as one of a multilayer ceramic capacitor (MLCC), a solid electrolytic (or tantalum) capacitor, a film capacitor, and a silicon wafer-based capacitor, but is not limited thereto. For example, MLCCs may provide various capacitor component models, and a manufacturer of the power module for a vehicle may select a capacitor component model corresponding to characteristics optimized for the current requirements of the power module for a vehicle among the characteristics of the various capacitor component models.

For example, a portion of the lead frame 400 may be disposed to overlap at least one of the first insulating layer 110 and the first metal layer 120 in a direction (e.g., the Z-direction) in which the first insulating layer 110 and the first metal layer 120 face each other, and the capacitor components C-com, C-com1, C-com2, C-com3, and C-com4 may not overlap the first and second circuit boards 100 and 150 in a direction (e.g., the Z-direction) in which the first insulating layer 110 and the first metal layer 120 face each other.

For example, the AC electrode 430 of the lead frame 400 may further include a plurality of AC electrodes 430 electrically connected to the first switching unit 200 and/or the second switching unit 300, and the plurality of DC electrodes 410 and 420 may be arranged (e.g., adjacently) to not have a plurality of AC electrodes 430 therebetween. Accordingly, an electrical distance between the plurality of DC electrodes 410 and 420 and the first switching unit 200 may be shortened, and the transmission energy efficiency may be improved. Compared to the transmission energy efficiency of the AC current, the transmission energy efficiency of the DC current may have a greater impact on the overall energy efficiency of the power module for a vehicle.

As the electrical distance between the plurality of DC electrodes 410 and 420 and the first switching unit 200 becomes shorter, the parasitic inductance corresponding to the electrical distance may also become smaller, and the required capacitance of the capacitor component C-com, C-com1, C-com2, C-com3, and C-com4 to offset the parasitic inductance may also become smaller.

For example, the number of the plurality of DC electrodes 410 and 420 may be three and the number of the plurality of AC electrodes 430 may be three, but is not limited thereto. For example, among the plurality of DC electrodes 410 and 420, two DC electrodes 420 on both sides may be N-type electrodes (or P-type electrodes), and among the plurality of DC electrodes 410 and 420, one DC electrode 410 in the middle may be a P-type electrode (or N-type electrode). This structure may be provided as an N-P-N busbar structure (or a P-N-P busbar structure).

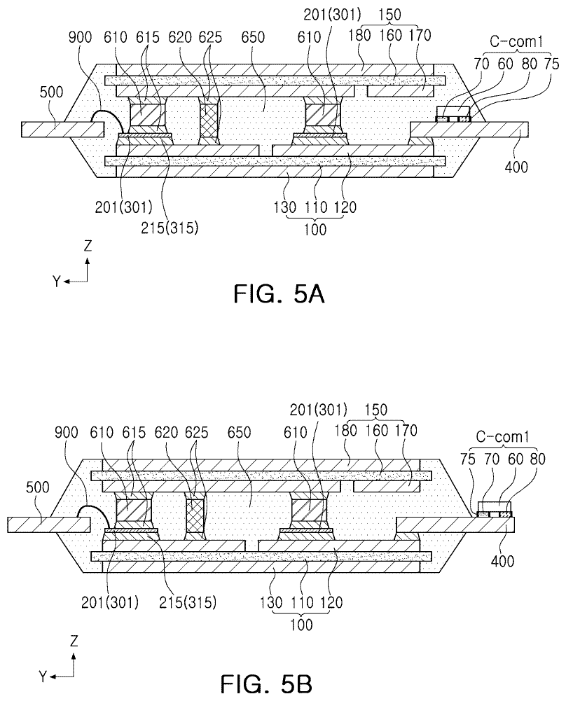

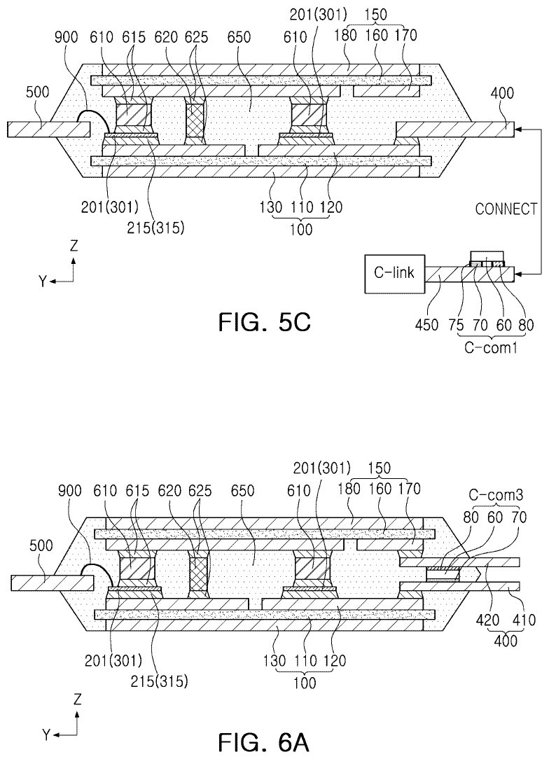

Referring to at least one of FIGS. 3A to 3C and at least one of FIGS. 5A to 5C, the power module for a vehicle according to an embodiment of the present disclosure may further include a fused portion 75 connected between the plurality of DC electrodes 410 and 420 and the capacitor component C-com1, and including a conductive material having a lower melting point than that of the plurality of DC electrodes 410 and 420. For example, the fused portion 75 may be implemented with a solder material or a sinter material and may be formed through a reflow process or a thermal compression bonding (TCB) process for a structure in which the capacitor component C-com1 is disposed on at least one of the plurality of DC electrodes 410 and 420.

For example, the capacitor component C-com1 may include a capacitor body 60 and a plurality of capacitor electrodes 70 and 80 arranged in the capacitor body 60. The capacitor body 60 may have a structure that (e.g., efficiently) forms capacitance (e.g., a structure in which a metal-dielectric-metal structure is efficiently compressed). The plurality of capacitor electrodes 70 and 80 may provide an electrical path that transfers the capacitance of the capacitor body 60 to the outside of the capacitor component C-com1 and may be electrically connected to a plurality of DC electrodes 410 and 420, respectively.

The capacitor component C-com1 may be disposed in a bridge structure crossing between the plurality of DC electrodes 410 and 420. For example, one of the plurality of capacitor electrodes 70 and 80 may be electrically connected to one of the plurality of DC electrodes 410 and 420 through a portion of the fused portion 75, and the other of the plurality of capacitor electrodes 70 and 80 may be electrically connected to the other of the plurality of DC electrodes 410 and 420 through another portion of the fused portion 75. Accordingly, a space between the plurality of DC electrodes 410 and 420 may be (e.g., efficiently) utilized (e.g., utilized to secure a space required for capacitance formation), and an electrical short between the plurality of DC electrodes 410 and 420 (or an electrical short between a portion of the fused portion 75 and another portion) may be stably prevented.

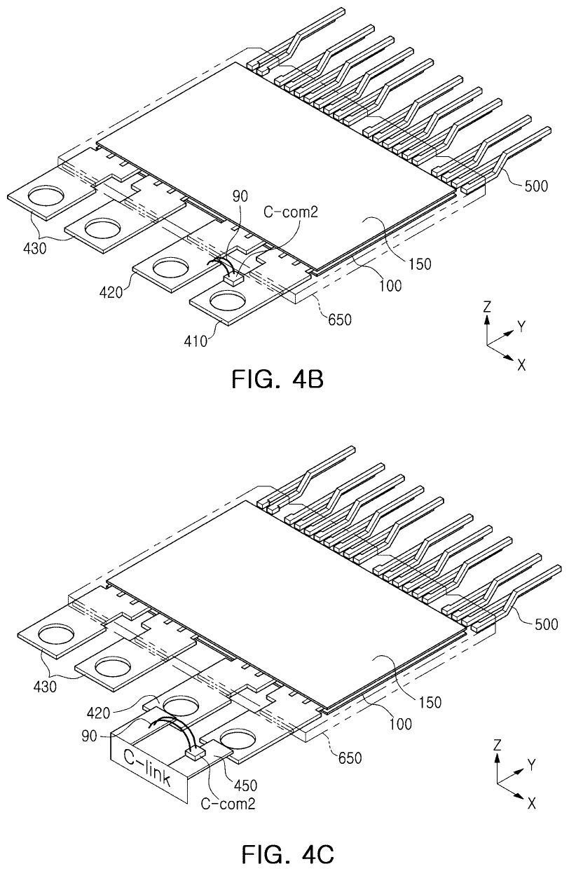

Referring to FIGS. 4A to 4C, the capacitor component C-com2 may further include a capacitor bonding wire 90 connected to one of the plurality of capacitor electrodes 70 and 80. One of the plurality of capacitor electrodes 70 and 80 may be electrically connected to one of the plurality of DC electrodes 410 and 420 via a capacitor bonding wire 90, and the other of the plurality of capacitor electrodes 70 and 80 may be electrically connected to the other of the plurality of DC electrodes 410 and 420. Accordingly, the degree of freedom in shape and the degree of freedom in arrangement of the capacitor component C-com2 may be increased. For example, the capacitor bonding wire 90 may include a material having high conductivity, ductility, and malleability, such as gold (Au), but is not limited thereto.

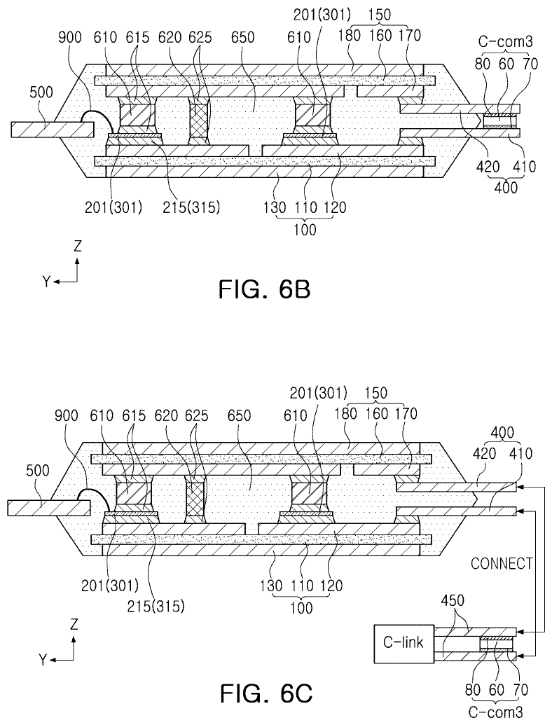

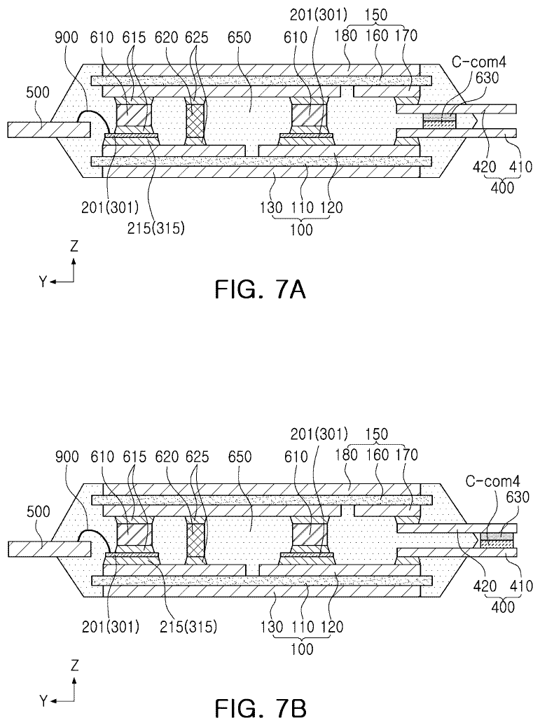

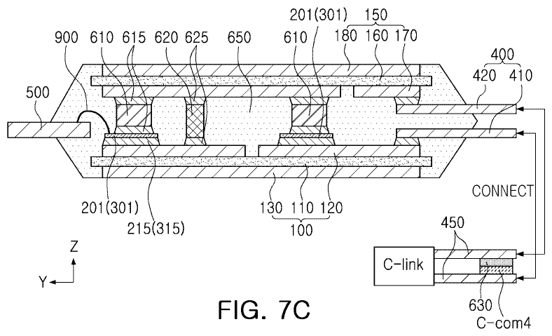

Referring to at least one of FIGS. 6A to 6C and at least one of FIGS. 7A to 7C, one of the plurality of DC electrodes 410 and 420 may be electrically connected to the first metal layer 120, the other of the plurality of DC electrodes 410 and 420 may be electrically connected to the second metal layer 170, and the capacitor components C-com3 and C-com4 may overlap the plurality of DC electrodes 410 and 420 in a direction (e.g., in the Z direction) in which the plurality of DC electrodes 410 and 420 face each other.

One of the plurality of capacitor electrodes 70 and 80 of the capacitor components C-com3 and C-com4 may be electrically connected to one of the plurality of DC electrodes 410 and 420, and the other of the plurality of capacitor electrodes 70 and 80 may be electrically connected to the other of the plurality of DC electrodes 410 and 420. Accordingly, the space between the first and second circuit boards 100 and 150 may be (e.g., efficiently) utilized.

For example, since the plurality of DC electrodes 410 and 420 may support the capacitor components C-com3 and C-com4 in the vertical direction, the capacitor components C-com3 and C-com4 may be mounted on the plurality of DC electrodes 410 and 420 without a separate structure (e.g., a fused portion) for fixing to the plurality of DC electrodes 410 and 420.

Referring to FIGS. 7A to 7C, the power module for a vehicle according to an embodiment of the present disclosure may further include a capacitor spacer 630 disposed between the plurality of DC electrodes 410 and 420 (or between the plurality of DC busbars 450) to overlap the capacitor component C-com4 in a direction (e.g., the Z-direction) in which the plurality of DC electrodes 410 and 420 face each other. Since the capacitor spacer 630 may support the capacitor component C-com4 in the vertical direction, the capacitor component C-com4 may be mounted on one of the plurality of DC electrodes 410 and 420 without a separate structure (e.g., a fused portion) for fixing to one of the plurality of DC electrodes 410 and 420.

One of the plurality of capacitor electrodes 70 and 80 of the capacitor component C-com4 may be electrically connected to one of the plurality of DC electrodes 410 and 420, and the other of the plurality of capacitor electrodes 70 and 80 may be electrically connected to the other of the plurality of DC electrodes 410 and 420 via the capacitor spacer 630.

For example, the capacitor spacer 630 may be implemented as a block formed of a conductive material or may be implemented as a structure in which a conductive pillar and an insulating block surrounding the conductive pillar are coupled, but is not limited thereto. For example, the capacitor spacer 630 may be connected and bonded to the capacitor component C-com4 and the DC electrode 420 via a spacer connection portion. The capacitor spacer 630 may have a thickness corresponding to a difference between a gap between the plurality of DC electrodes 410 and 420 and the thickness of the capacitor component C-com4, so that the arrangement of the capacitor component C-com4 may be stabilized by supporting the capacitor component C-com4 downward.

The power module for a vehicle according to an embodiment of the present disclosure may include a switching unit spacer 610 and/or a via spacer 620. The switching unit spacer 610 and the via spacer 620 may each provide an electrical connection path for the second circuit board 150, so that the capacitor electrode 80 of the capacitor components C-com3 and C-com4 may be electrically connected to the first and second semiconductor chips 201 and 301 or the first metal layer 120.

The switching unit spacer 610 may be disposed between the first semiconductor chip 201 of the first switching unit 200 and the second circuit board 150 to electrically connect the first switching unit 200 and the second metal layer 170. The via spacer 620 may be disposed between the first circuit board 100 and the second circuit board 150 to electrically connect the first metal layer 120 and the second metal layer 170.

Spacer connection portions 615 and 625 may connect the switching unit spacer 610 and/or the via spacer 620 to the second metal layer 170, may connect the switching unit spacer 610 to the first semiconductor chip 201 of the first switching unit 200, and may connect the via spacer 620 to the first metal layer 120. For example, the spacer connection portions 615 and 625 may be implemented as a block formed of a conductive material or may be implemented as a structure in which a conductive pillar and an insulating block surrounding the conductive pillar are combined, but is not limited thereto.

The switching unit spacer 610 may stabilize the arrangement of the first semiconductor chip 201 by supporting the first semiconductor chip 201 of the first switching unit 200 downwardly and may also provide a path for dissipating heat generated by the first semiconductor chip 201 upwardly.

Referring to at least one of FIGS. 3A, 4A, 5A, 6A, AND 7A, the encapsulant 650 may be disposed on the first circuit board 100, may be disposed between the first and second circuit boards 100 and 150, and may encapsulate the first, second and third switching units 200, 300, and 700 and the capacitor components C-com, C-com1, C-com2, C-com3, and C-com4. The encapsulant 650 may protect the first, second and third switching units 200, 300, and 700 from the outside of the power module for a vehicle, while also protecting the capacitor components C-com, C-com1, C-com2, C-com3, and C-com4. For example, the encapsulant 650 may include a molding material, such as epoxy molding compound (EMC), or a silicone gel, but is not limited thereto.

Referring to at least one of FIGS. 3B, 4B, 5B, 6B, and 7B, the encapsulant 650 may be disposed on the first circuit board 100, may be disposed between the first and second circuit boards 100 and 150, may encapsulate the first, second, and third switching units 200, 300, and 700, and may encapsulate a portion of each of the plurality of DC electrodes 410 and 420, but the capacitor components C-com, C-com1, C-com2, C-com3, and C-com4 may be spaced apart from the encapsulant 650.

Referring to at least one of FIGS. 3C, 4C, 5C, 6C and 7C, the lead frame 400 may further include a plurality of DC busbars 450 electrically connected between the plurality of DC electrodes 410 and 420 and the DC link capacitor C-link, and the capacitor components C-com1, C-com2, C-com3, and C-com4 may be mounted on at least one of the plurality of DC busbars 450. Accordingly, the capacitor components C-com1, C-com2, C-com3, and C-com4 may be provided independently of the power module for a vehicle, and thus may also have optimized characteristics.

Since the plurality of DC busbars 450 and the plurality of DC electrodes 410 and 420 may be required to allow flow high-voltage DC current to (e.g., efficiently and stably) flow therethrough, the plurality of DC busbars 450 may be implemented similarly (e.g., similar in shape/width/thickness/material) to the plurality of DC electrodes 410 and 420.

One end (e.g., one end in the −Y-direction) of the plurality of DC electrodes 410 and 420 may be connected to the plurality of DC busbars 450. For example, the plurality of DC busbars 450 may be at least a portion of a busbar structure electrically connecting the plurality of DC electrodes 410 and 420 to the battery (e.g., BAT in FIG. 1A) or may be shunt-connected to the busbar structure. For example, one end (e.g., one end in the +Y-direction) of each of the plurality of DC busbars 450 may be physically coupled (e.g., fastened, bonded) to one end of the plurality of DC electrodes 410 and 420 through a plurality of holes formed in one end (e.g., one end in the −Y-direction) of the plurality of DC electrodes 410 and 420.

The distance (e.g., exceeding the length of each of the plurality of DC electrodes 410 and 420 in the Y-direction) from the other end of each of the plurality of DC electrodes 410 and 420 to the capacitor component C-com1, C-com2, C-com3, and C-com4 may be greater than the distance (e.g., the length of the AC electrode 430 in Y-direction) between one end and the other end of the AC electrode 430. For example, the length of each of the plurality of DC electrodes 410 and 420 in Y-direction and the length of each of the plurality of AC electrodes 430 may be substantially the same, and most of the plurality of DC busbars 450 may be positioned farther in the −Y-direction than one end of the AC electrode 430 in the −Y direction, so that the capacitor components C-com1, C-com2, C-com3, and C-com4 may also be positioned farther than one end of the AC electrode 430 in the −Y-direction.

The capacitor spacer 630 may be disposed between the plurality of DC busbars 450 to overlap the capacitor component C-com4 in a direction in which the plurality of DC busbars 450 face each other (e.g., in the Z direction). The capacitor component C-com4 may be disposed between the plurality of DC busbars 450. Accordingly, while the plurality of DC busbars 450 are connected to the plurality of DC electrodes 410 and 420, an electrical short between the plurality of DC busbars 450 may be stably prevented, and the capacitor component C-com4 may also be stably prevented from escaping from the plurality of DC busbars 450.

Referring to FIG. 2 and at least one of FIGS. 3A to 7C, the power module for a vehicle according to an embodiment of the present disclosure may further include at least one of the current sensor (e.g., 800 of FIG. 2), the bonding wire 900, and the signal lead 500.

The current sensor (e.g., 800 of FIG. 2) may sense current flowing through the first metal layer 120 and may be disposed between the first and second circuit boards 100 and 150. For example, the current sensor (e.g., 800 of FIG. 2) may be implemented to sense current and/or voltage of a resistor shunt-connected to the first metal layer 120 or may be implemented as a hall sensor, but is not limited thereto.

One end of the bonding wire 900 may be connected to the first, second, and third switching units 200, 300, and 700 and the current sensor (e.g., 800 of FIG. 2), and the other end of the bonding wire 900 may be connected to the first metal layer 120 or the signal lead 500. For example, the bonding wire 900 may include a material having high conductivity, ductility, and electrical conductivity, such as gold (Au), but is not limited thereto.

The signal lead 500 may be electrically connected to the first, second, and third switching units 200, 300, and 700 and may be disposed on the other side (e.g., a +Y-direction) of the first and second circuit boards 100 and 150. The signal lead 500 may be disposed to be offset from the center of the first and second circuit boards 100 and 150 in the +Y-direction. The signal lead 500 may receive a control signal from the outside (e.g., a controller) of the power module for a vehicle and transmit the control signal to the first, second, and third switching units 200, 300, and 700. In addition, the signal lead 500 may transmit a current value sensed by the current sensor (e.g., 800 of FIG. 2) to the outside (e.g., the controller) of the power module for a vehicle.

The power module for a vehicle including a capacitor component and the motor driving apparatus including the same according to an embodiment of the present disclosure may (e.g., efficiently) reduce the influence (e.g., fluctuation/surge/ringing of voltage/current due to switching for power conversion) of parasitic inductance of the power module for a vehicle, and may increase the power conversion efficiency of the power module for a vehicle (e.g., switching unit) or reduce the required specifications (e.g., withstand voltage characteristics).

For example, the parasitic inductance of the power module for a vehicle assembled with the other structures excluding the capacitor components may be slightly variable depending on the embodiment (e.g., design) specifications and/or process dispersion of the other structures. The capacitor components may be additionally disposed in the power module for a vehicle assembled with the other structures and may be selected as an optimized one among various capacitor component types, so that they may provide the power module for a vehicle with a more optimized capacitance to offset the current parasitic inductance.

While embodiments have been shown and described above, it may be apparent to those skilled in the art that modifications and variations may be made without departing from the scope of the present disclosure as provided by the appended claims.

What is claimed is:

1. A power module for a vehicle, the power module comprising:
a first circuit board including a first insulating layer and a first metal layer disposed on the first insulating layer;
a lead frame including a plurality of direct current (DC) electrodes disposed on the first circuit board;
a first switching unit electrically connected to the plurality of DC electrodes and disposed on the first circuit board; and
a capacitor component disposed on the lead frame to be electrically connected between the plurality of DC electrodes.

2. The power module of claim 1, further comprising a fused portion connected between the capacitor component and at least one of the plurality of DC electrodes, the fused portion including a conductive material having a lower melting point than a melting point of each of the plurality of DC electrodes.

3. The power module of claim 2, wherein
the capacitor component is disposed in a bridge structure crossing between the plurality of DC electrodes, and
the capacitor component includes a capacitor body and a plurality of capacitor electrodes disposed in the capacitor body, and
at least one of the plurality of capacitor electrodes is electrically connected to at least one of the plurality of DC electrodes through a first portion of the fused portion, and at least one of the plurality of capacitor electrodes is electrically connected to at least one of the plurality of DC electrodes through a second portion of the fused portion.

4. The power module of claim 1, wherein
the capacitor component includes a capacitor body, a plurality of capacitor electrodes disposed in the capacitor body, and a capacitor bonding wire connected to at least one of the plurality of capacitor electrodes,
at least one of the plurality of capacitor electrodes is electrically connected to at least one of the plurality of DC electrodes, and
the capacitor bonding wire connects at least one of the plurality of capacitor electrodes to at least one of the plurality of DC electrodes.

5. The power module of claim 1, further comprising an encapsulant disposed on the first circuit board and encapsulating the first switching unit and the capacitor component.

6. The power module of claim 1, further comprising:
an encapsulant disposed on the first circuit board and encapsulating the first switching unit and a portion of each of the plurality of DC electrodes,
wherein the capacitor component is separated from the encapsulant.

7. The power module of claim 1, further comprising:
a second circuit board including a second insulating layer and a second metal layer disposed on the second insulating layer,
wherein the capacitor component does not overlap the first and second circuit boards in a direction in which the first and second circuit boards face each other.

8. The power module of claim 1, further comprising:
a second circuit board including a second insulating layer and a second metal layer disposed on the second insulating layer,
wherein at least one of the plurality of DC electrodes is electrically connected to the first metal layer and at least one of the plurality of DC electrodes is electrically connected to the second metal layer, and
the capacitor component overlaps the plurality of DC electrodes in a direction in which the plurality of DC electrodes face each other.

9. The power module of claim 8, further comprising a capacitor spacer disposed between the plurality of DC electrodes to overlap the capacitor component in a direction in which the plurality of DC electrodes face each other.

10. The power module of claim 9, wherein
the capacitor component includes a capacitor body and a plurality of capacitor electrodes disposed in the capacitor body, and
a first capacitor electrode of the plurality of capacitor electrodes is electrically connected to a first DC electrode of the plurality of DC electrodes, and
a second capacitor electrode of the plurality of capacitor electrodes is electrically connected to a second DC electrode of the plurality of DC electrodes.

11. The power module of claim 8, further comprising a via spacer disposed between the first circuit board and the second circuit board to electrically connect the first metal layer to the second metal layer.

12. The power module of claim 8, further comprising a switching unit spacer disposed between the first switching unit and the second circuit board to electrically connect the first switching unit to the second metal layer.

13. The power module of claim 1, wherein
the lead frame further includes a plurality of alternating current (AC) electrodes electrically connected to the first switching unit, and
the plurality of DC electrodes are adjacent to not to have the plurality of AC electrodes therebetween.

14. The power module of claim 13, further comprising a signal lead electrically connected to the first switching unit and disposed the first circuit board.

15. The power module of claim 1, wherein
the lead frame further includes a plurality of DC busbars electrically connected between a DC link capacitor and the plurality of DC electrodes, and
the capacitor component is disposed on at least one of the plurality of DC busbars.

16. The power module of claim 15, wherein
the lead frame further includes an AC electrode electrically connected to the first switching unit, and
a first end of each of the plurality of DC electrodes is connected to each of the plurality of DC busbars, and
a distance from a second end of each of the plurality of DC electrodes to the capacitor component is greater than a distance between a first end and a second end of the AC electrode.

17. The power module of claim 15, further comprising:
a capacitor spacer disposed between the plurality of DC busbars to overlap the capacitor component in a direction in which the plurality of DC busbars face each other,
wherein the capacitor component is disposed between the plurality of DC busbars.

18. The power module of claim 1, further comprising:
a second switching unit disposed on the first circuit board; and
a third switching unit disposed on the first circuit board,
wherein the first switching unit includes a plurality of first semiconductor chips, the second switching unit includes a plurality of second semiconductor chips, and the third switching unit includes a third semiconductor chip.

19. The power module of claim 18, wherein
the first switching unit is disposed in a central portion of the first circuit board,
the second switching unit is disposed outwardly of the first switching unit on the first circuit board, and
the third switching unit is disposed outwardly of the first switching unit on the first circuit board.

20. A motor driving apparatus comprising
a power module including:
a first circuit board including a first insulating layer and a first metal layer disposed on the first insulating layer;
a lead frame including a plurality of direct current (DC) electrodes disposed on a side of the first circuit board;
a first switching unit electrically connected to the plurality of DC electrodes and disposed on the first circuit board;
a capacitor component disposed on the lead frame to be electrically connected between the plurality of DC electrodes;
a second switching unit disposed on the first circuit board; and
a third switching unit disposed on the first circuit board,
wherein the first switching unit includes a plurality of first semiconductor chips, the second switching unit includes a plurality of second semiconductor chips, and the third switching unit includes a third semiconductor chip,
wherein the first switching unit includes a 1-1 switching element and a 1-2 switching element and corresponds to a leg of a first inverter,
the second switching unit includes a 2-1 switching element and a 2-2 switching element and corresponds to a leg of a second inverter, and
at least one end of the third switching unit is connected between a first node between the 1 -1 switching element and the 1-2 switching element and a second node between the 2-1 switching element and the 2-2 switching element and constitutes part of a changeover switch.
